(19) United States
(12) Patent Application Publication
(10) Pub. No.: US 2015/0360621 A1
(43) Pub. Date: Dec. 17, 2015

(54) CARGO MAT SYSTEM

(71) Applicants: Brady Atherton, Blaine, MN (US); Matt Halseth, Hawley, MN (US)

(72) Inventors: Brady Atherton, Blaine, MN (US); Matt Halseth, Hawley, MN (US)

(73) Assignee: Furious Innovation, LLC., Hawley, MN (US)

(21) Appl. No.: 14/737,972

(22) Filed: Jun. 12, 2015

Related U.S. Application Data
(60) Provisional application No. 62/012,284, filed on Jun. 14, 2014.

(51) Int. Cl. B60R 13/01

(52) U.S. Cl. CPC B60R 13/01; B60R 2013/016; B60R 2013/018

(57) ABSTRACT

A cargo mat system comprising a cargo mat including a mat portion configured to cover at least a portion of a cargo area of a vehicle and a partition portion coupled to the mat portion, the partition portion comprising one or more securing structures, wherein the partition portion is movable from a lowered position to a raised position relative to the mat portion, and one or more partition mounts coupleable to the vehicle, the one or more partition mounts engageable with the one or more securing structures to hold the partition portion in the raised position relative to the mat portion.

### CROSS-REFERENCE TO RELATED APPLICATION

This application claims priority under 35 U.S.C. §119(e) to U.S. Provisional Application Ser. No. 62/012,284, filed on Jun. 14, 2014, which is incorporated herein by reference in its entirety.

### BACKGROUND

The present disclosure relates to cargo areas for vehicles and, more particularly, to a cargo mat system. Cargo often shifts when vehicles are in transit. This can be particularly frustrating for pickup truck or SUV drivers when they have to climb into the bed of the truck to retrieve items that slide towards the cab. Cargo securing devices that are currently commercially available typically must be removed in order to regain full functionality of the cargo area. Units sold currently can also be bulky and take up space from the cargo area so that the cargo area cannot be fully utilized.

### SUMMARY

The present disclosure describes a cargo mat system that can be used as a bed cover to manage cargo in a cargo area, such as a bed of a pickup truck or the cargo space of an SUV. The cargo mat system can comprise a mat configured to cover a surface area of a vehicle cargo area and a first barrier coupled to the mat, the first barrier operable to move from an approximately horizontal position relative to the mat to an approximately vertical position relative to the mat.

### BRIEF DESCRIPTION OF THE FIGURES

FIG. 1 is a perspective front view of an example cargo mat system.

FIG. 2 is a perspective view of various configurations of the example cargo mat system shown in FIG. 1.

FIG. 3 is a perspective view of another example cargo mat system installed in the bed of a pickup truck. The cargo mat system includes a cargo mat with a partition portion in a lowered, flat position.

FIG. 4 is a perspective view of the example cargo mat system and pickup truck shown in FIG. 3 with the partition portion of the cargo mat in a raised position.

FIG. 5 is a side view of the example cargo mat system and pickup truck shown in FIG. 3 with the partition portion of the cargo mat in the lowered position.

FIG. 6 is a side view of the example cargo mat system and pickup truck shown in FIG. 3 with the partition portion of the cargo mat in the raised position.

FIG. 7 is a side view of the example cargo mat system and pickup truck shown in FIG. 3 with the partition portion of the cargo mat being at an intermediate position between the lowered position and the raised position.

FIG. 8 is an end view of the example cargo mat system and pickup truck shown in FIG. 3 with the partition portion in the raised position.

FIG. 9 is a side cross-sectional view of a cargo mat of the example cargo mat system shown in FIG. 3.

FIG. 10 is a side view of example mounting hooks that are used to secure the partition portion in the raised position.

FIG. 11 is a close-up perspective view of the partition portion being engaged by an example mounting hook.

FIG. 12 is a side view of an example mounting strap to secure the partition portion in the raised position.

FIG. 13 is a side view of the example mounting strap of FIG. 12 with the strap inserted through a mounting window in the partition portion and securing to an example securing hook.

FIG. 14 is a front view of the example mounting strap shown in FIGS. 12 and 13.

FIG. 15 is a perspective view of the example cargo mat system shown in FIG. 3 with the partition portion in the raised position and a rigid reinforcing member separated from the partition portion.

FIG. 16 is a close-up perspective view of the partition portion of the cargo mat, showing a recess therein for receiving the rigid reinforcing member.

### DETAILED DESCRIPTION

In the following Detailed Description, reference is made to the accompanying drawings which form a part hereof. The drawings show, by way of illustration, specific examples in which the present molding systems and methods can be practiced. These examples are described in sufficient detail to enable those skilled in the art to practice, and it is to be understood that other embodiments can be utilized and that structural changes can be made without departing from the scope of the present disclosure. Terms indicating direction, such as front, rear, left, right, up, and down, are generally used only for the purpose of illustration or clarification and are not intended to be limiting. The following Detailed Description is not to be taken in a limiting sense, and the scope of the present disclosure is defined by the appended claims and their equivalents.

This disclosure describes a cargo mat system that can include a mat configured to cover a surface area of a vehicle cargo area, such as a floor of a pickup truck bed. As used herein, the term “mat” or “cargo mat” can refer to a member that can be placed over the floor or frame of the cargo area of a vehicle, such as the bed floor of a pickup truck. A “mat” or “cargo mat,” as used herein, can be substantially flat, e.g. substantially planar, although it need not be. A “mat” or “cargo mat,” as used herein, can be made as an aftermarket product sold separately from the vehicle in which it is to be installed, or the “mat” or “cargo mat” can be manufactured by the manufacturer of the vehicle and installed by the manufacturer when the vehicle is made in factory, either as a standard or optional feature of the vehicle. For example, a “mat” or “cargo mat,” as used herein, can be a separate and removable structure that is placed in the cargo area, or the “mat” or “cargo mat,” as used herein, can be installed to be integral or substantially integral with the vehicle.

In an example, the mat can be configured to cover approximately the entire surface area of the cargo area, such as the entire bed floor of a pickup truck. A barrier can be coupled to the mat and can be movable between an approximately horizontal position relative to the mat (e.g., the left most drawing of FIG. 2), to an approximately vertical position relative to the mat (e.g., FIG. 2 and the middle and right most drawings of FIG. 2). In an example, the barrier can be coupled to the mat so that it is positioned relative to a forward part of the cargo area (e.g., within a close distance of the tailgate of a pickup truck to allow for easy access to cargo that is secured by the barrier). Therefore, the primary barrier of the cargo mat system can be described herein as a “forward barrier.” However, the cargo mat system of the present disclosure is not limited to being coupled at a forward position, and one or more barriers of the cargo mat system can be coupled at other positions of the mat. The cargo mat system can also include a barrier mount that is capable of removably securing the barrier in the approximately vertical position relative to the mat.

The device can have multiple barriers that can be folded up and locked into approximately upright positions to create compartments that prevent cargo from shifting while a vehicle is in motion. When the barriers are folded down, the device can lie flat, e.g., the barriers and the mat can form a generally planar top surface which can allow vehicle users to use the entire cargo area.

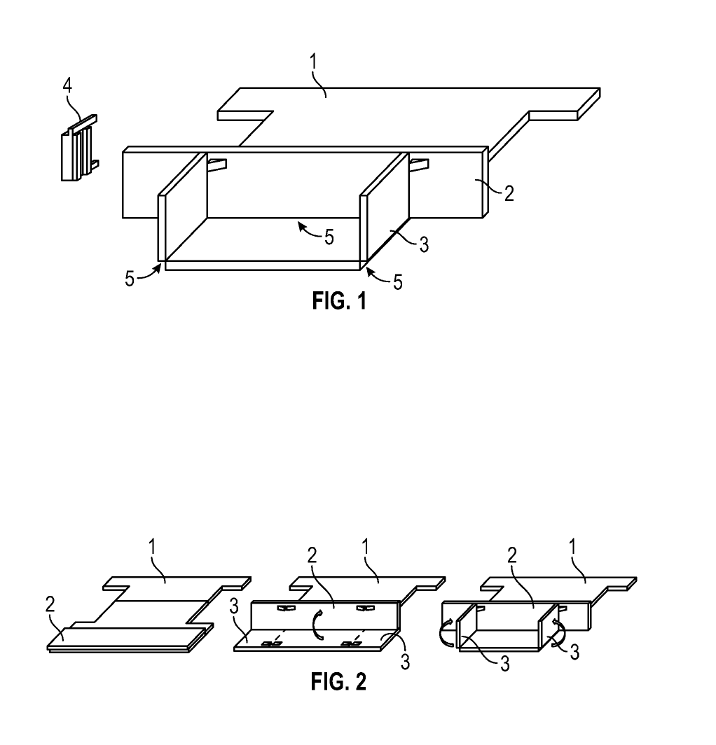

As is illustrated in FIGS. 1 and 2, a cargo mat system can include a cargo mat 1. The mat 1 can cover at least a portion of a horizontal surface of a cargo area, and in some examples the mat 1 can cover approximately the entire surface of a bed of a vehicle. A first barrier, e.g., a forward barrier 2, can be attached to the mat 1. The forward barrier 2 can move from an approximately horizontal position relative to the mat 1 to an approximately vertical position relative to the mat 1. The forward barrier 2 can be coupled to the mat with a folding mechanism 5, which can allow the forward barrier 2 to move between the approximately horizontal position and the approximately vertical position. Examples of folding mechanisms 5 included, but are not limited 5 to, friction mounts, peg and hole systems, hinges, or the like.

The system can also include a barrier mount 4 that can be removably coupled to the forward barrier 2 to secure the forward barrier 2 in the approximately vertical position. The barrier mount 4 can be attached to a side wall of the vehicle, e.g., the sidewall of a pickup bed, by a clamp, fastener, or the like. The forward barrier 2 can be secured in position by being removably coupled to the barrier mount 4.

In an example, at least one second barrier 3 can be coupled to the mat 1 or to the first barrier 2. In the example shown in FIGS. 1 and 2, the at least one second barrier 3 can be generally perpendicular to the first barrier 2 so that the at least one second barrier 3 can form lateral compartments for the storage of cargo in the cargo area. For this reason, the at least one second barrier 3 are also referred to herein as “lateral barriers 3.” The at least one lateral barrier 3 can move from an approximately horizontal position relative to the mat 1, to an approximately vertical position relative to the mat 1.

A method of making the cargo mat system can include constructing the mat 1, the forward barrier 2, and (if present) the lateral barriers 3 out of a plastic, rubber material or the like, such as by cutting one or more of the mat 1, the forward barrier 2, and (if present) the lateral barriers 3 from manufactured sheets of the desired material or molding one or more of the mat 1, the forward barrier 2, and (if present) the lateral barriers 3, such as with specialized molding equipment. One or more of the mat 1, the forward barrier 2, and (if present) the lateral barriers 3 can also include a rigid structure, such as an aluminum or other metal plate within or next to the plastic or rubber material, so that the structures are sufficiently rigid to resist bending when contacted by cargo within the cargo area. The barrier mount 4 can be made from a metal, rubber, plastic material or the like, and can be constructed by hand or produced by a specialized facility with injection molding, machining, or the like. The folding mechanisms 5 can be fastened to the mat 1 and the barriers 2, 3. In an example, the folding mechanism 5 can be fastened to the forward barrier 2 and the lateral barriers 3. In an example, the folding mechanism 5 can be molded into the mat 1, the forward barrier 2 and the lateral barriers 3. In an example, additional barriers can be added to provide additional areas of compartments. In an example, the lateral barriers 3 can be freestanding and inserted into grooves or other support structures that can be molded into the mat 1, the forward barrier 2, or both. The forward barrier 2 can also be freestanding and inserted into grooves in the barrier mount 4, the mat 1, or both. The device can be configured so that the lateral barriers 3 can be folded down before the forward barrier 2 can be folded down, e.g., so that the forward barrier 2 can rest on the mat 1 and the folded down lateral barriers 3.

A method of installing the cargo mat system can include placing the cargo mat system into the cargo area of a vehicle, such as by laying the device down in the appropriate location. In an example, the device can be custom fit or shaped for a particular cargo area, such as by cutting out portions to accommodate the wheel wells of a pickup truck. The barrier mounts 4 can next be connected to a side wall of the vehicle, which in the case of a pickup, can require a clamp or a fastener that can secure the barrier mount 4 to the metal lip under the bed rail. In SUV's and other vehicles other methods can be used. Before fully securing the barrier mounts 4, the forward barrier 2 can be folded up to a desired approximately vertical position (e.g., with a desired orientation relative to the mat 1) so that the barrier mounts 4 can be aligned to ensure the forward barrier 2 can approximately vertically level when connected to the barrier mounts 4. When level, set the forward barrier 2 back down and fully secure the barrier mounts 4. Any or all of the installation steps can be performed by the end user (e.g., the pickup truck owner or leaser), or by a trained installer, such as an employee of an automobile dealership or retailer from which the cargo mat system was purchased.

To use the cargo mat system, a user can simply grab a portion of the forward barrier 2, such as an edge, and fold the forward barrier 2 up into the approximately vertical position. When the forward barrier 2 reaches the barrier mount 4, the forward barrier 2 can be secured by the barrier mount 4, for example by the user pushing the forward barrier 2 into the barrier mount 4, which can lock the forward barrier 2 in place in the approximately vertical position. Next, the user can grab one or more of the lateral barriers 3 (if present) and fold the selected lateral barrier or barriers 3 upward to an approximately vertical position. When the one or more lateral barriers 3 reach an approximately vertical position, the lateral barrier 3 can be secured in place relative to the mat 1 and the forward barrier 2, such as in a groove located on one or both of the mat 1 and the forward barrier 2.

To regain a flat device, the user can simply disengage the one or more lateral barriers 3 from their securement, e.g., by disengaging the one or more lateral barriers 3 from the grooves, and fold the one or more lateral barriers 3 back down. Next, the user can disengage the forward barrier 2 from the barrier mount 4 and fold the forward barrier 2 back down.

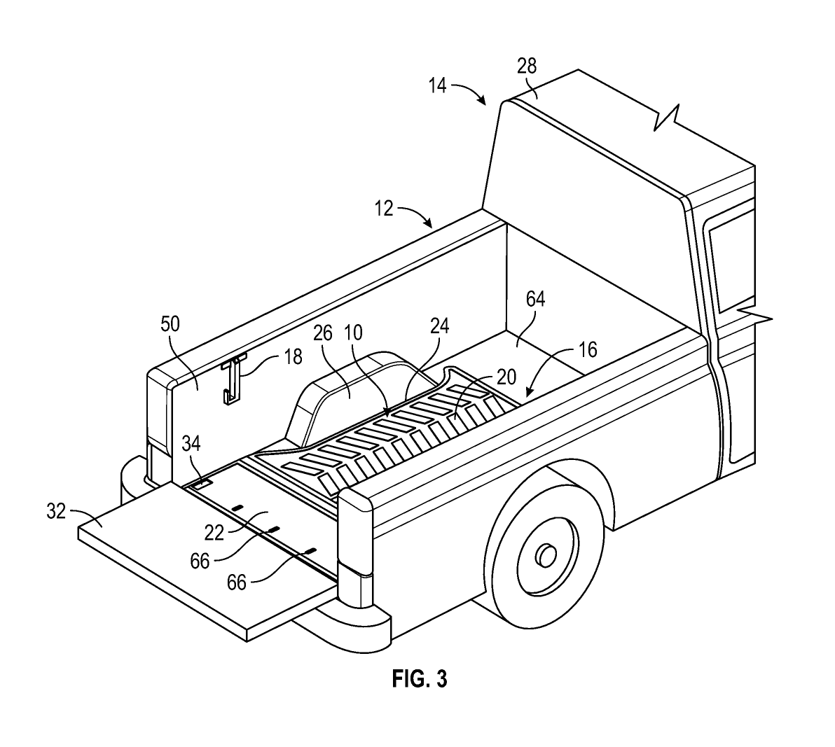

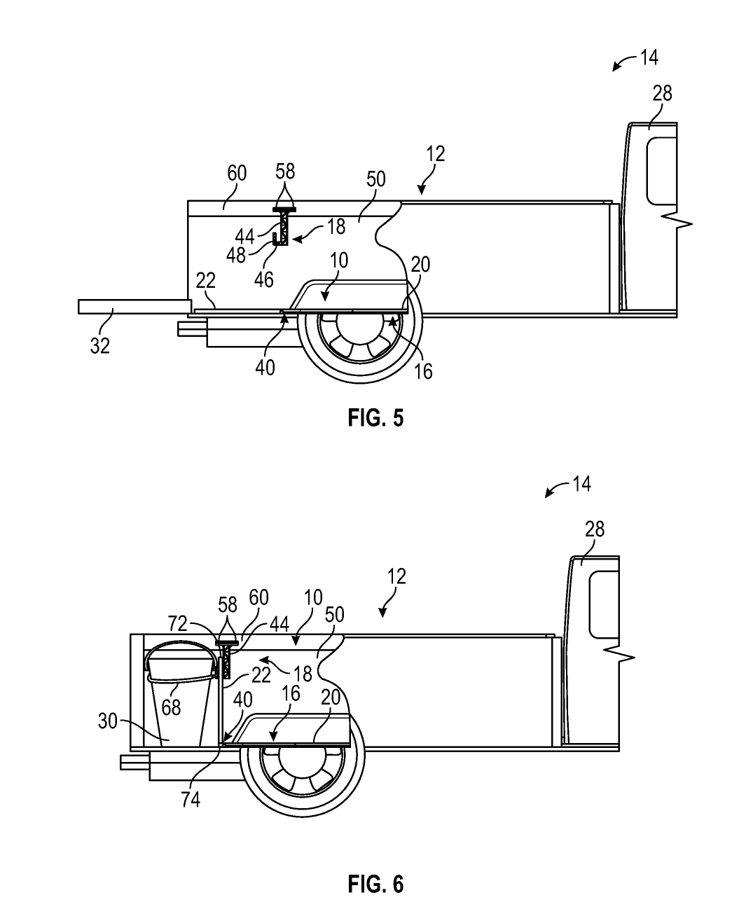

FIGS. 3-16 show another example cargo mat system 10 for use in a cargo area 12 of a vehicle 14. The cargo mat system 10, as shown in these figures, is specifically designed for use in a bed of a pickup truck, although it could be modified for use in other cargo areas, such as in the rear of a sport-utility vehicle (SUV) or a van. For the sake of brevity, the remainder of this disclosure will describe the vehicle 14 as a pickup truck 14, the cargo area 12 as the bed 12 of the pickup truck 14, and the cargo mat system 10 as being configured for a pickup truck 14, but it will be understood by a person of ordinary skill in the art that the cargo mat system 10 can be modified for use in other vehicle types.

### Cargo Mat

The cargo mat system 10 can include a cargo mat 16 and one or more partition mounts 18. The cargo mat 16 can comprise a mat portion 20 configured to cover at least a portion of the bed 12 of the pickup truck 14 and a partition portion 22 coupled to the mat portion 20. In an example, the cargo mat 16 can cover substantially the entire floor of the bed 12. One or both of the portions 20, 22 of the cargo mat 16 can be formed from a non-slip material to prevent or minimize sliding of the cargo mat 16 within the truck bed 12 and to prevent or minimize sliding or shifting of cargo along the top surface of the cargo mat 16. In an example, the non-slip material comprises a rubber material, such as a molded rubber, for example recycled rubber, which can be reinforced or unreinforced. Examples of rubber that can be used to form the cargo mat 16 include, but are not limited to, rubbers sold under the trade names NYRACORD and SYMAR by Koneta Inc., Wapakoneta, Ohio, USA. Both the mat portion 20 and the partition portion 22 can comprise a molded rubber, and in an example, the entire cargo mat 16 can be formed from the same molded piece of rubber so that both the mat portion 20 and the partition portion 22 for a unitary mat that is molded at substantially the same time. In an example, the cargo mat 16, e.g., the mat portion 20 and the partition portion 22, can be formed by compression molding the rubber material.

The mat portion 20 can have a shape designed to accommodate structural aspects of the pickup bed 12, such as cutouts 24 for wheel wells 26 within the pickup truck bed 12. The mat portion 20 can have a shape that is designed and fitted to correspond to the bed 12 of a particular model or models of pickup truck 14. For example, the mat portion 20 of one cargo mat 16 can be fitted to the bed dimensions of a Ford F-150, a second cargo mat 16 can be fitted to the bed dimensions of a Ford F-250, a third cargo mat 16 can be fitted to the bed dimensions of a Chevrolet Silverado, a fourth cargo mat 16 can be fitted to the bed dimensions of a Toyota Tundra, and a fifth cargo mat 16 can be fitted to the bed dimensions of a Ram pickup truck. Moreover, each truck model can have different options for dimensions of a cab 28 of the pickup truck 14 (e.g., standard cab, crew cab, super crew cab, etc.) and of the bed 12 (e.g., standard bed length or extended bed lengths). For example, a manufacturer may have models of pickup trucks 14 with a bed 12 having lengths of, but not limited to, about 5.5 feet, about 6.5 feet, or about 8 feet, plus or minus a few inches. The cargo mat 16 described herein is not limited to the examples of truck models mentioned above. Cargo mats 16 for other pickup truck manufacturers and models can be made. Examples of pickup truck manufacturers for which the cargo mat 15 can be can include, but are not limited to: Ford (e.g., F-150, F-250 Super Duty, F-350 Super Duty, F-450 Super Duty, and Ford Commercial Trucks); Chevrolet (e.g., Silverado, Colorado, and Chevrolet Commercial trucks); GMC (e.g., Sierra 1500, Sierra 2500, Sierra 3500); Honda (e.g., Ridgeline); Nissan (e.g., Frontier, Titan); Ram (formerly Dodge Ram) (e.g., Ram 1500, Ram 2500, Ram 3500, Ram Chassis Cab); and Toyota (e.g., Tacoma and Tundra). If desired, a different cargo mat 16 can be made for each of a selected set of pickup truck models (including for each of a selected set of model years) and for each of a selected set of bed option.

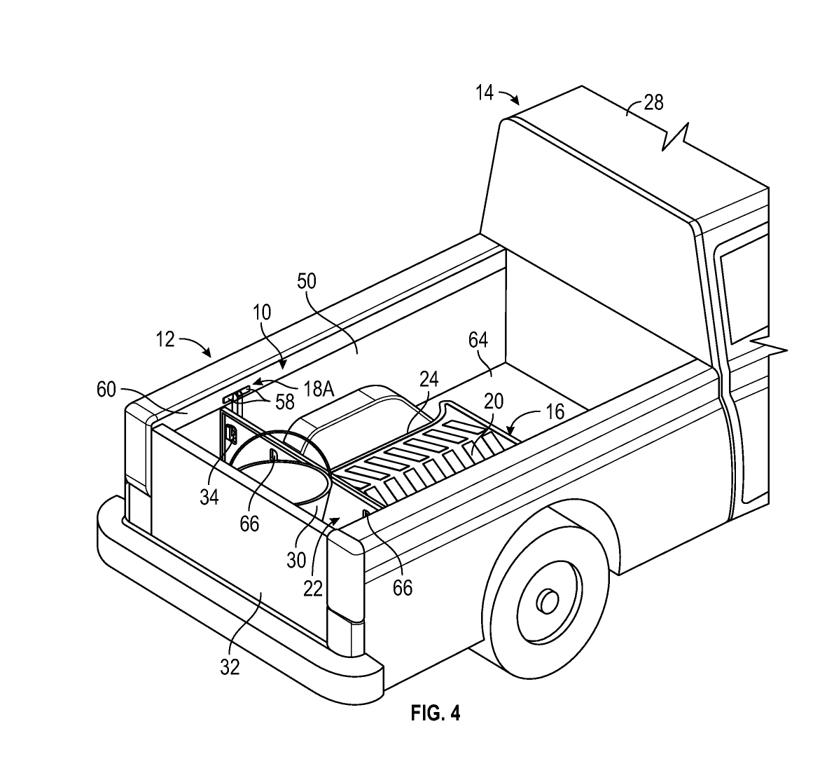

The partition portion 22 can be movable from a lowered position (FIGS. 3, 5, and 9) to a raised position (FIGS. 4, 6, 8, 11-15) relative to the mat portion 20. When in the lowered position, the partition portion 22 and the mat portion 20 can together provide a generally flat top surface when the partition portion 22 is in the lowered position. When in the raised position, the partition portion 22 can provide a barrier for cargo placed within a designated portion of the truck bed 12 to prevent or minimize shifting of the cargo. For example, as shown in FIGS. 6 and 8, when the partition portion 22 is in the raised position, a cargo object 30 can be prevented from shifting in the forward-rearward direction (e.g., from the cab 28 toward a tailgate 32 and vice versa), with the tailgate 32 preventing rearward shifting and the partition portion 22 preventing forward shifting toward the cab 28.

The partition portion 22 can include one or more securing structures 34 that can be engaged by the one or more partition mounts 18 to secure the partition portion 22 in the raised position relative to the mat portion 20. In an example, each of the one or more securing structures 34 of the partition portion 22 is engaged by a corresponding one of the one or more partition mounts 18.

### Living Hinge

As described above the partition portion 22 can be pivoted between a generally flat lowered position and a generally upright or generally vertical raised position. The partition portion 22 can be pivoted relative to the mat portion 20, e.g., so that the partition portion pivots upward as it moves from the lowered position to the raised position and pivots downward as it moves from the raised position to the lowered position. The cargo mat 16, therefore, can include one or more hinging mechanisms 40 that pivotally couple the partition portion 22 to the mat portion 20.

In an example, the one or more hinging mechanisms 40 can comprise one or more living hinges 40 between the mat portion 20 and the partition portion 22. The one or more living hinges 40 can comprise a single living hinge 40 that extends laterally across the entire width, or approximately across the entire width, of the cargo mat 16. As used herein, the term “living hinge” can refer to a flexible hinge that is made from the same material as the pieces it is pivotally coupling together rather than another material or mechanism separate from the pieces being connected. An advantage of a living hinge 40 is that it results in little to no friction or wear during use, and thus can prevent or minimize damage to the cargo mat 16 or the truck bed 12 or both. The use of a living hinge 40 can also simplify manufacturing of the cargo mat 16 because it can eliminate the need of a separate step for coupling the mat portion 20 and the partition portion 22 together during manufacture of the cargo mat system 10. Typically, a living hinge comprises the material being selectively cut or is formed to be thinner than the pieces being connected to allow for pivotal hinging of the living hinge.

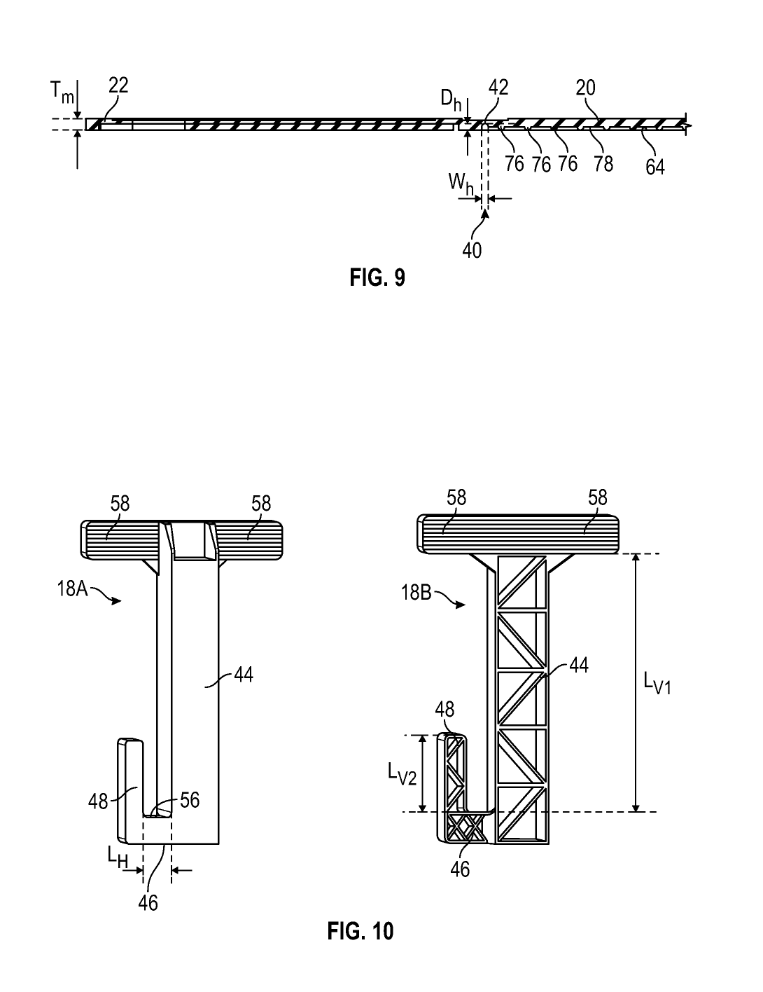

FIG. 9 is a cross-sectional view of the cargo mat 16 showing a close up view of an example living hinge 40. The one or more living hinges 40 of the cargo mat 16 can be formed by molding the one or more living hinges 40 and at least a portion of the mat portion 20 and at least a portion of the partition portion 22 together, e.g., in the same mold, with the mold including a thinned portion to form each of the one or more living hinges 40. As described above, in an example, the mat portion 20 and the partition portion 22 can be formed as a single piece of material, e.g., by molding both the mat portion 20 and the partition portion 22 together. Therefore, in an example where the mat portion 20 and the partition portion 22 are molded as a single piece, the mold can be shaped to also form the one or more living hinges 40 between the portions 20 and 22.

In an example, each portion 20, 22 of the cargo mat 16 can have thickness Tₘ (FIG. 9) from about ⅛ inch (about 3 mm) to about ¾ inch (about 19 mm), such as from about ¼ inch (about 6.4 mm) to about ½ inch (about 13 mm), for example about ⅜ inch (about 9.5 mm). The living hinge 40 can have a depth Dₕ from about ⅛ inch (about 3 mm) to about ⅜ inch (about 9.5 mm), such as about ¼ inch (about 6.4 mm), but the depth Dₕ that is chosen can depend on the thickness Tₘ of the cargo mat 16. The width Wₕ of the living hinge 40 when the partition portion 22 is in the lowered position can be from about 1/16 inch (about 1.6 mm) to about ¼ inch (about 6.4 mm), such as about ⅛ inch (about 3 mm). The living hinge 40 can have a curved upper edge 42, where the curvature of the curved upper edge 42 can provide for prevention and minimization of wearing and tearing of the cargo mat 16 at the living hinge 40 due to the pivoting motion of the partition portion 22 relative to the mat portion 20.

### Mounting Structures

The partition mounts 18 can comprise any structure capable of engaging the partition portion 22 in order to secure the partition portion 22 in the raised position. In an example, shown in FIGS. 3-11 and 15, the partition mounts 18 comprise hooks 18 that engage a corresponding securing structure 34 on the partition portion 22 by hooking onto the securing structure 34. In an example, the securing structures 34 comprise securing windows 34 through the partition portion 22 through which the hooks 18 can be inserted so that the hooks 18 can hook onto the partition portion 22. An advantage of using one or more securing windows 34 as the one or more securing structures 34 is that they allow the partition portion 22 to remain substantially planar so that when the partition portion 22 is in the lowered position, the cargo mat 16 will be substantially flat throughout substantially the entire truck bed 12.

As best seen in FIG. 10, each hook 18 can comprise a first substantially vertical member 44 (referred to herein simply as “first vertical member 44” for the sake of brevity) mountable to the pickup truck 14, a substantially horizontal member 46 (referred to herein as “horizontal member 46” for brevity) coupled to the first vertical member 44, and a second substantially vertical member 48 (referred to herein as “second vertical member 48” for brevity) coupled to the horizontal member 46.

The first vertical member 44 can be coupled to a structure of the pickup truck 14, such as to a side wall 50 of the truck bed 12. The first vertical member 44 can extend generally vertically downward from its mount so that the hook 18 can engage a corresponding securing structure 34 of the partition portion 22. The length L_{V1} of the first vertical member 44 (FIG. 10) can be selected so that the horizontal member 46 and the second vertical member 48 will be aligned with the corresponding securing structure 34 (e.g., a corresponding securing window 34) of the partition portion 22.

The horizontal member 46 can extend into or through the securing structure 34 (e.g., the securing window 34) so that the hook 18 can engage the securing structure 34. In an example, the horizontal member 46 can extend rearward (e.g., toward the tailgate 32) from the first vertical member 44 so that the hook 18 extends rearward through the corresponding hole 24. The horizontal member 46 can have a length L_{H} (FIG. 10) that is configured so that the hook 18 will protrude completely through the securing window 34.

The second vertical member 48 can extend generally vertically upward from the horizontal member 46 so that the second vertical member 48 can engage a portion of the partition portion 22, such as a front surface 52 of the partition portion 22 vertically above the securing window 34. The length L_{V2} of the second vertical member 48 (FIG. 10) can be selected so that at least an upper portion of the second vertical member 48 engages the front surface 52 above the securing windows 34. In this way, the second vertical member 48 can prevent the partition portion 22 from moving substantially in a first horizontal direction (e.g., a forward horizontal direction), while the first vertical member 44 can prevent the partition portion 22 from moving substantially in a second horizontal direction (e.g., a rearward horizontal direction), wherein the second horizontal direction can be diametrically opposed to the first horizontal direction, so that the hook 18 secures the partition portion 22 between the substantially vertical members 44, 48 when the partition portion 22 is in the raised position.

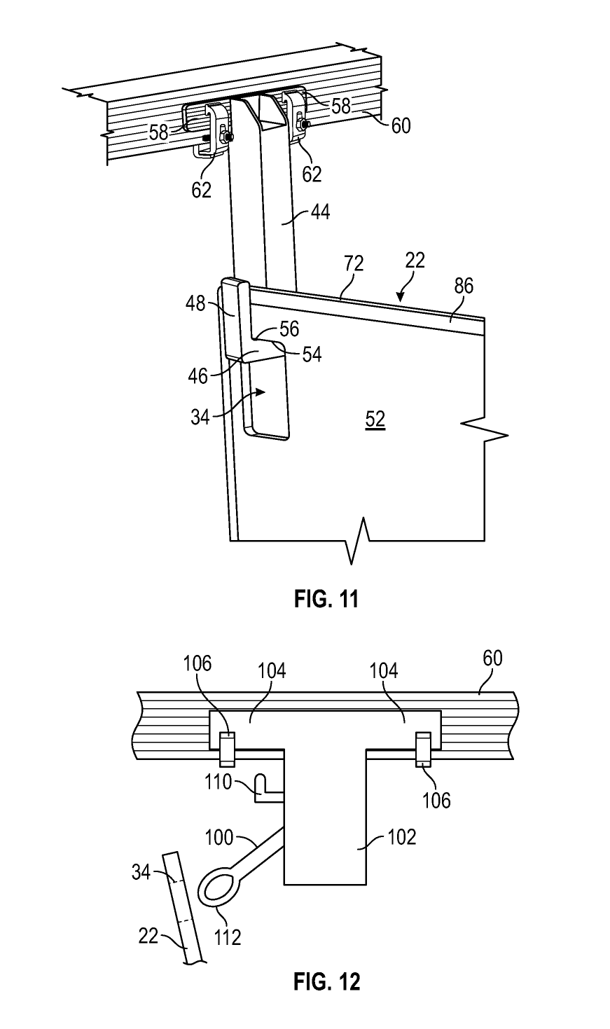

A top edge 54 of the securing window 34 can rest on and be supported by a top edge 56 of the horizontal member 46 (FIG. 11). The width W_{w} of the securing windows 34 (FIG. 16) can be selected so that side-to-side shifting of the partition portion 22 in the bed 12 of the pickup truck 14 (e.g., left to right in FIG. 8) will be minimal and within an acceptable limit. The width W_{w} and a height H_{w} of the securing windows 34 (FIG. 16) can be selected to allow for variance in the positioning of the hook 18 relative to the partition portion 22 due to differences in dimensions of the bed 12 due to differences in truck models or manufacturing variance for a particular model.

Each securing hook 18 can comprise one or more mounting structures 58 configures to mount the securing hook 18 to the pickup truck 14, for example to mount the securing hook 18 to the side wall 50 of the truck bed 12. In an example, the one or more mounting structures 58 can include one or more mounting wings 58 that can be secured to a lip 60 that protrudes downward from the top of the side wall 50 of the truck bed 12. In many pickup trucks 14, the lip 60 is a standard byproduct from the manufacture of the side wall 50 so that the mounting wings 58 can be secured to the side wall 50 without the need to install specialized mounts to the side wall 50 other than the hook 18. The mounting wings 58 can be secured to the lip 60 by any fastener or other securing device that will reliably secure the wings 58 to the lip 60. As shown in the example of FIG. 11, the cargo mat system 10 can include one or more fasteners for securing a hook 18 to the lip 60, such as one or more clamps 62 that can clamp the one or more mounting wings 58 to the lip 60. In an example, the one or more mounting wings 58 can include grooves and ridges that can substantially mate with corresponding grooves and ridges on an interior clamping surface of a clamp 62, best seen in FIG. 11, to prevent or reduce shifting of the one or more mounting wings 58 relative to the clamp 62. In an example, the one or more clamps 62 can comprise the aluminum clamps sold by LOTO Equipment Co., Camdenton, Mo., USA, doing business as accesscover.net, as part number 10155.

The lengths L_{V1}, L_{V2} of the vertical members 44, 48 (FIG. 10) can be selected so that the one or more hooks 18 can be mounted at the same spot within the truck bed 12 of the same model of pickup truck 14 (e.g., a Ford F-150) but can still accommodate slightly different positioning of the securing structures 34 (e.g., the securing windows 34) that can occur due to different configurations of that pickup truck model. For example, one owner of a first Ford F-150 might have opted to use the cargo mat 16 by itself as the only liner in the truck bed 12, so that the cargo mat 16 rests directly on the bottom surface 64 of the truck bed 12, e.g., the factory installed bottom surface 64. A second owner of a second Ford F-150 might have opted to first put in a thin rubber bed liner on the factory installed bed 12 and then place the cargo mat 16 on the thin rubber bed liner so that the cargo mat 16 is raised slightly, e.g., about ¼ inch (about 6.35 mm), compared to the cargo mat 16 in the first truck bed 12. A third owner of a third Ford F-150 might have opted to install a plastic bed liner inside the entire truck bed 12 (bottom surface 64 and the interior of the side walls), which can be even thicker than the thin rubber bed liner used in the second Ford F-150, e.g., about ½ inch (about 12.7 mm) higher than the cargo mat 16 in the truck bed 12 of the first Ford F-150. Finally, a fourth owner of a fourth Ford F-150 might have opted to install both the plastic bed liner that the third owner used and the rubber mat liner that the second owner used, so that the cargo mat 16 is about ¾ inch (about 19 mm) higher than the cargo mat in the first Ford F-150. The four trucks 14 of the four owners could have been identical when they rolled off the Ford production line. The mounting hooks 18 in each of the four trucks 14 can be mounted and positioned in substantially the same position relative to the bottom surface 64. But, the cargo mats 16 in the four trucks 14 are each at different heights relative to the bottom surface 64 of the truck beds 12 and relative to the structure of the truck 14 to which the partition mounts 18 (e.g., the mounting hooks 18) are secured, e.g., the lip 60. In an example, the lengths L_{V1}, L_{V2} of the vertical members 44, 48 can be selected so that both vertical members 44, 48 will be able to engage the section of the partition portion 22 that is above the securing window 34 in each of the four example trucks 14, even though the securing windows 34 may be at different heights relative to the bottom surface 64 of the truck bed 12.

In some examples, the mounting hooks 18 and the partition portion 22 can be designed and sized for use in a specific model of pickup truck 14 or truck bed 12 such that a different version of the mounting hooks 18 and partition portion 22 can be designed for each model of pickup truck 14 (or group of models of pickup truck 14). In another example, the mounting hooks 18 and the partition portion 22 can be designed so that a single design or a relatively small number of designs of the mounting hooks 18 can be used for substantially all models of pickup truck 14, or at least a subset of pickup trucks 14 corresponding to popular models of pickup trucks 14. For example, the sizing of one or both of the mounting hooks 18 and the securing windows 34 and the positioning of the mounting hooks 18 in the truck bed 12 and the securing windows 34 in the partition portion 22 can allow for a minimum number of designs for the hooks 18. For example, the size and positioning of the windows 34 for each specific partition portion 22 (e.g., corresponding to different dimensions of the truck bed 12 corresponding to different models of pickup truck 14) can allow for only a single design of the securing hook 18, or a small number of designs of hooks 18 to accommodate different sizes, such as one hook 18 for smaller-sized pickup trucks (e.g., the Dodge Dakota) and one hook 18 for larger-sized pickup trucks (e.g., the Ford F-250 Super Duty). The use of a single design for the hook 18, or a small number of designs for the hooks 18, can allow for a simple inventory for one or more of the manufacturer of the cargo mat system 10, the supplier of the cargo mat system 10, the seller of the cargo mat system 10, and the installer of the cargo mat system 10.

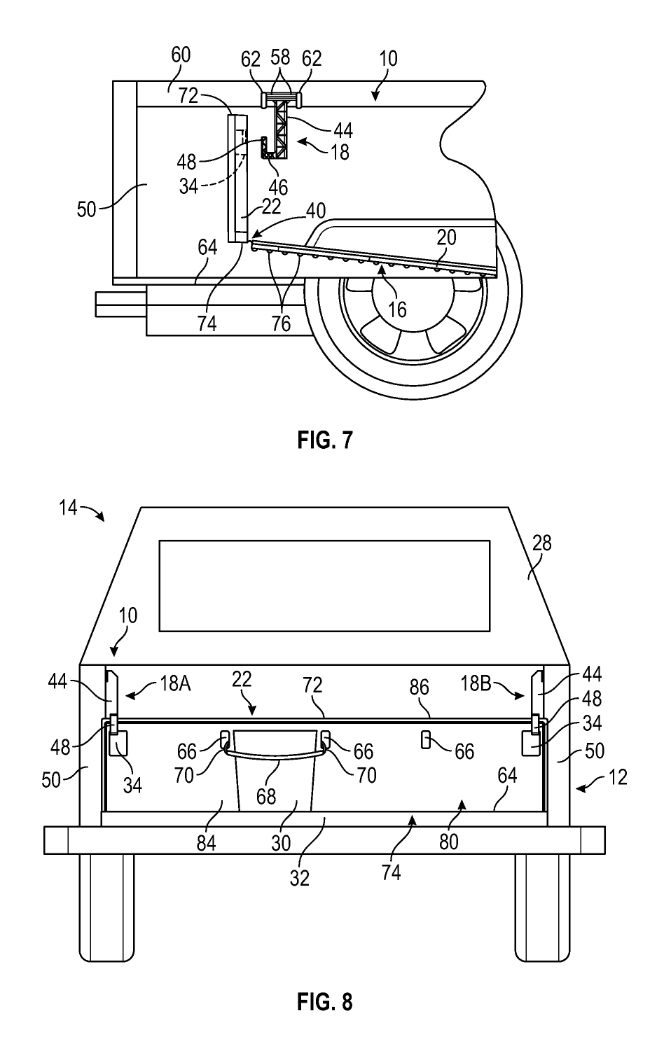

In order to engage the securing windows 34 with the hooks 18, a user can lift the partition portion 22 from the lowered position and begin pivoting the partition portion 22 toward the hooks 18. When the securing windows 34 are near the hooks 18, the user can lift the partition portion 22 directly upward, which will cause the partition portion 22 and the mat portion 20 to be raised slightly above the bottom surface 64 of the truck bed 12, as shown in FIG. 7. By raising the partition portion 22, the securing windows 34 can be in a position so that the entire second vertical member 48 can be inserted through the securing window 34 (see FIG. 7). After inserting the second vertical members 48 completely through the securing windows 34, the cargo mat 16 can be lowered down so that the section of the partition portion 22 above the securing window 34 is positioned and secured between the vertical members 44, 48, as described above.

In another example, shown in FIGS. 12-14, the partition mounts can include one or more straps 100 or other tying device that can be coupled with a corresponding securing structure 34 of the partition portion 22, e.g., by inserting the one or more straps 100 through the mounting window 34 of the partition portion 22 to secure the partition portion 22 in the raised position. The strap 100 can be coupled to a mounting member 102, and the mounting member 102 can be mounted to the pickup truck 14, for example by mounting the mounting member 102 to the side wall 50 of the truck bed 12, similar to the mounting of the mounting hooks 18 to the pickup truck 12 described above. One or more mounting wings 104, or other mounting structures, can extend from the mounting member 102, and the mounting wings 104 can be secured to the pickup truck 12, such as with clamps 106. The mounting wings 104 and the clamps 106 can be substantially identical to the mounting wings 58 and the clamps 62 described above.

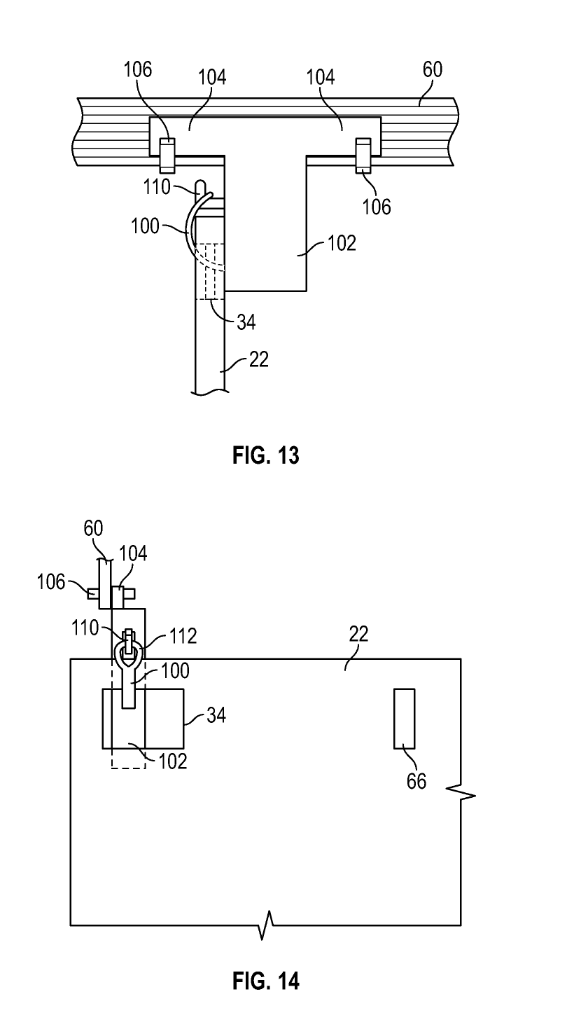

Each of the one or more straps 100 can comprise an elastic strap 100, such as a rubber or bungee-like strap, which can be elongated/stretched to insert the strap 100 through the mounting window 34. The elastic nature of the strap 100 can then exert a restraining force on the partition portion 22 to secure the partition portion 22 in the raised position. Each of the one or more straps 100 can be secured, e.g., tied, hooked, or otherwise secured, to a securing structure 110 on the mounting member 102. In an example, the securing structure 110 can comprise a securing hook 110 and the strap 100 can include a loop 112 that can be placed onto the securing hook 110 to secure the strap 100 to the mounting member 102. A user can raise the partition portion 34 to be in close proximity to the mounting member 102, as shown in FIG. 12, and then the user can insert the strap 100 through the mounting window 34, pull the strap 100 up toward the securing structure 110 and engage the strap 100 with the securing structure, such as by placing the loop 112 onto the securing hook 110, as shown in FIGS. 13 and 14. The elastic strap 100 can tightly hold the partition portion 22 against a front surface 114 of the mounting member 102, e.g., due to the elastic properties of the elastic strap 100.

The partition mounts, such as the mounting hooks 18 or the mounting member 102, can be configured and positioned to minimize the distance that they laterally protrude into the truck bed 12 (e.g., rightward in from the left side wall 50 and leftward in from the right side wall 50 in FIG. 8). As demonstrated best in FIGS. 8 and 10, each of the members 44, 46, and 48 that form the mounting hooks 18 have a generally planar, generally flat shape with its narrowest dimensions being aligned laterally with the truck bed 12, e.g., so that the hooks are thin in the lateral direction and do not protrude unnecessarily into the truck bed 12 to interfere with loading larger cargo in the truck bed 12.

In an example, shown in FIGS. 8 and 10, the hooks 18 can comprise mirror image hooks 18A, 18B, with a first hook 18A for mounting to the pickup truck 14 on a first side of the bed 12 (e.g., the left side in FIG. 8) and a second hook 18B for mounting to the pickup truck 14 on a second side of the bed 12 (e.g., the right side in FIG. 8).

The partition mounts (e.g., the mounting hooks 18 or the mounting member 102 with the strap 100) can comprise a material that is sufficiently strong and tough to withstand being repeatedly impacted by the partition portion 22 or by cargo 30 within the truck bed 12. The partition mounts can comprise a polymer, such as a toughened polymer to withstand such impact. In an example, the partition mounts comprise a polyamide, such as a nylon. In an example, the partition mounts comprise a toughened or super toughened polyamide, such as a toughened nylon or a super toughened nylon. Examples of toughened nylon that can be used to form the partition mounts include, but are not limited to, nylons to which a toughening medium, such as one or more elastomers, have been added, including, but not limited to, toughened or super toughened nylons sold under the ZYTEL trade name by DuPont Performance Polymers, a division of E. I. Du Pont de Nemours and Co., Wilmington, Del., USA, such as ZYTEL 70G33HS1L BK031, which is a nylon 66 polyamide that has been heat stabilized and reinforced with 33 wt. % glass reinforcement. The material of the partition mounts will preferably remain sufficiently tough and resistant to damage from impact at any temperature to which the pickup truck 14 is expected to be exposed. The partition mounts can be made of a material that will maintain acceptable mechanical properties at temperatures as low as −40° F. (−40° C.), such as as low as about −30° F. (about −34° C.), for example as low as about −25° F. (about −32° C.), such as as low as −20° F. (about −29° C.), for example as low as about −15° F. (about −26° C.), such as as low as about −10° F. (about −23° C.), for example as low as about −5° F. (about −20° C.), such as as low as about 0° F. (about −18° C.). The partition mounts can be made of a material that will maintain acceptable mechanical properties at temperatures as high as about 140° F. (about 60° C.), such as as high as 130° F. (about 54° C.), for example as high as about 125° F. (about 52° C.), such as as high as about 120° F. (about 49° C.), for example as high as about 115° F. (about 46° C.), such as as high as about 110° F. (about 43° C.), for example as high as about 105° F. (about 40° C.), such as as high as about 100° F. (about 37° C.). In an example, the partition mounts can be made of a material that can withstand temperatures of from about −40° F. (about −40° C.) to about 140° F. (60° C.), such as from about −30° F. (about −34° C.) to about 120° F. (about 49° C.), for example from about −20° F. (about −29° C.) to about 110° F. (about 43° C.), such as from about −10° F. (about −23° C.) to about 100° F. (about 37° C.).

While the one or more partition mounts and securing structures 34 have been described in detail as one or more mounting hooks 18 or one or more straps 100 that engage the one or more securing windows 34, a person of ordinary skill in the art will appreciate that other mounting devices and mating securing structures can be used to secure the partition portion 22 in the raised position, including, but not limited to, latches (such as: a gate latch; a door latch; a toggle latch, or a cabinet latch), magnets (such as a magnet coupled to the pickup truck side wall 50 and a corresponding metal plate or mating magnet coupled to the partition portion 22), a hole and peg/pin/cotter system (such as a spring loaded peg mounted to the partition portion 22 that mates with a hole coupled to the pickup truck 14, or a spring loaded peg mounted to the pickup truck 14 that mates with a hole on the partition portion 22), a nut and bolt system, a friction fit coupling, or a locking hinge for the hinging mechanism 40 (e.g., a hinge that allows pivoting for a certain portion of the travel of the partition portion 22, but that locks the partition portion 22 in position when the partition portion reaches a certain height).

### Tying Structures

The partition portion 22 can include structures to allow for further securing of the cargo 30 when the partition portion 22 is in the raised position. As shown in FIGS. 4 and 8, the partition portion 22 can include one or more tying structures 66 that can allow one or more tying devices 54 to secure the cargo 30 to the partition portion 22. Bungee cords are common and popular tying devices 54 used to secure cargo in pickup truck beds, and, therefore, the tying devices 54 will be described as bungee cords 68. A person of ordinary skill in the art will understand that tying devices other than bungee cords 68 can be used to secure cargo 30, including, but not limited to, twine, string, rope, cable, chain, rubber bands, and the like. In an example, shown in FIGS. 4 and 8, the one or more tying structures 66 can comprise one or more tying holes 66 through the partition portion 22. The one or more tying holes 66 can provide a structure to which the one or more bungee cords 68 can be secured, for example by hooking bungee cord hooks 70 (FIG. 8) onto the partition portion 22 at a tying hole 66 or by passing the bungee cord 68 through one or more of the tying holes 66 and hooking the bungee cord hooks 70 onto the bungee cord 68 itself or onto the cargo 30. An advantage of using one or more tying holes 66 as the one or more tying structures 66 is that they allow the partition portion 22 to remain substantially planar so that when the partition portion 22 is in the lowered position, the cargo mat 16 will be substantially flat throughout substantially the entire truck bed 12.

The tying holes 66 can be located at least along a top edge 72 of the partition portion 22. The tying holes 66 can be located at other vertical locations of the partition portion 22 instead of or in addition to being located along the top edge 72, such as at a vertical middle of the partition portion 22 or proximate to a bottom edge 74 of the partition portion 22. In an example, a plurality of the tying holes 66 can be generally evenly spaced laterally (e.g., left to right in FIG. 8) across the length of the partition portion 22. The one or more securing windows 34 (e.g., for engaging with the one or more securing hooks 18) can be configured so that each can both receive a corresponding securing hook 18 and be used as a tying structure, either alone or in conjunction with one or more of the tying holes 66. In an example, the partition portion 22 comprises at least two (2) tying structures (which can include both the one or more tying holes 66 and the one or more securing windows 34), such as at least three (3) tying structures, for example at least four (4) tying structures, such as at least five (5) tying structures, for example at least six (6) tying structures, such as at least seven (7) tying structures, for example at least eight (8) tying structures, such as at least nine (9) tying structures, for example at least ten (10) tying structures, or more.

The cargo mat 16 can include a plurality of protrusions 76 on a bottom surface 78 of at least one of the mat portion 20 and the partition portion 22, best seen in FIG. 9. The protrusions 76, sometimes also referred to as cleats 76, can provide for one or both of airflow under the cargo mat 16 and water drainage from beneath the cargo mat 16.

### Rigid Reinforcing Member

As noted above, the portions 20, 22 of the cargo mat 16 can be formed out of a non-slip material, such as a rubber. In some examples, rubbers may not be sufficiently structurally sound to prevent the undesired shifting of cargo 30. Therefore, in an example, the cargo mat system 10 can further include a rigid reinforcing member 80 coupled to the partition portion 22 of the cargo mat 16. The rigid reinforcing member 80 can reinforce the rubber of the partition portion 22 in order to prevent shifting of the cargo 30 in the forward-backward direction within the truck bed 12.

The rigid reinforcing member 80 is coupled to the partition portion 22 of the cargo mat 16. The rigid reinforcing member 80 can be permanently or substantially permanently coupled to the partition portion 22. As used herein, the term “permanently or substantially permanently,” as used with respect to the coupling between the rigid reinforcing member 80 and the partition portion 22, can mean that the rigid reinforcing member 80 is secured to the partition portion 22 in such a manner that the two structures cannot be separated by typical use of the cargo mat system 10, nor can the structures be easily separated by manual attempts to do so. “Permanently or substantially permanently” is not intended to mean that it is impossible to separate the rigid reinforcing member 80 and the partition portion 22, as there may be situations where it is desirable to remove an original rigid reinforcing member 80, e.g., because of damage or wear, and replace it with a new rigid reinforcing member 80.

The rigid reinforcing member 80 can be coupled to the partition portion 22 by any structures, devices, or means that are capable of providing a desired coupling, which can include, but is not limited to, fasteners, clips, snaps, and adhesives. In an example, the rigid reinforcing member 80 can be coupled to the partition portion 22 with an adhesive capable of withstanding the temperatures to which the cargo mat system 10 will be exposed. As noted above, these temperatures can typically be from about −40° F. (about −40° C.) to about 140° F. (60° C.), such as from about −30° F. (about −34° C.) to about 120° F. (about 49° C.), for example from about −20° F. (about −29° C.) to about 110° F. (about 43° C.), such as from about −10° F. (about −23° C.) to about 100° F. (about 37° C.). Therefore, any adhesive used to couple the rigid reinforcing member 80 and the partition portion 22 will preferably be able to withstand very cold temperatures, e.g., as low as −40° F. (−40° C.), such as as low as about −30° F. (about −34° C.), for example as low as about −25° F. (about −32° C.), such as as low as −20° F. (about −29° C.), for example as low as about −15° F. (about −26° C.), such as as low as about −10° F. (about −23° C.), for example as low as about −5° F. (about −20° C.), such as as low as about 0° F. (about −18° C.). The adhesive will preferably be able to withstand very hot temperatures, e.g., as high as about 140° F. (about 60° C.), such as as high as 130° F. (about 54° C.), for example as high as about 125° F. (about 52° C.), such as as high as about 120° F. (about 49° C.), for example as high as about 115° F. (about 46° C.), such as as high as about 110° F. (about 43° C.), for example as high as about 105° F. (about 40° C.), such as as high as about 100° F. (about 37° C.). The adhesive can also preferably be able to withstand regular cycling between hot and cold temperatures over relatively short time frames (e.g., weeks, days, or even hours). In an example, the adhesive can comprise an adhesive configured for outdoor application for bonding plastics to rubber in hot and cold weather, such as one of several such adhesives sold by 3M Company, St. Paul, Minn., USA, including, but not limited to, 3M 2141 Neoprene Rubber and Gasket Adhesive, 3M 1099 Nitrile High Performance Plastic Adhesive, 3M 1099L Nitrile High Performance Plastic Adhesive, and 3M 1300 Neoprene High Performance Rubber and Gasket Adhesive. In an example, the rigid reinforcing member 80 can be coupled to the partition portion 22 with both an adhesive, such as at least one of the adhesives described above, and with fasteners, such as binding screws or rivets strategically positioned around the rigid reinforcing member 80 to maintain coupling if the adhesive were to partially or completely fail.

The rigid reinforcing member 80 can comprise any material that will provide sufficient strength or sufficient rigidity, or both, to the combined structure of the rigid reinforcing member 80 and the partition portion 22. The rigid reinforcing member 80 can comprise a rigid plastic, such as a sheet of rigid plastic coupled to the partition portion 22. In an example, the rigid plastic, such as the sheet of rigid plastic, can comprise acrylonitrile butadiene styrene (ABS), which is a particularly rigid plastic material. Other materials can be used to provide rigidity to the partition formed by the combined structure of the partition portion 22 and the rigid reinforcing member 80 including, but not limited to, other plastics (such as high-density polyethylene (HDPE), poly(methyl methacrylate) (PMMA), and polyvinyl chloride (PVC)), metals (such as aluminum), fiberglass, polyamides, and the like.

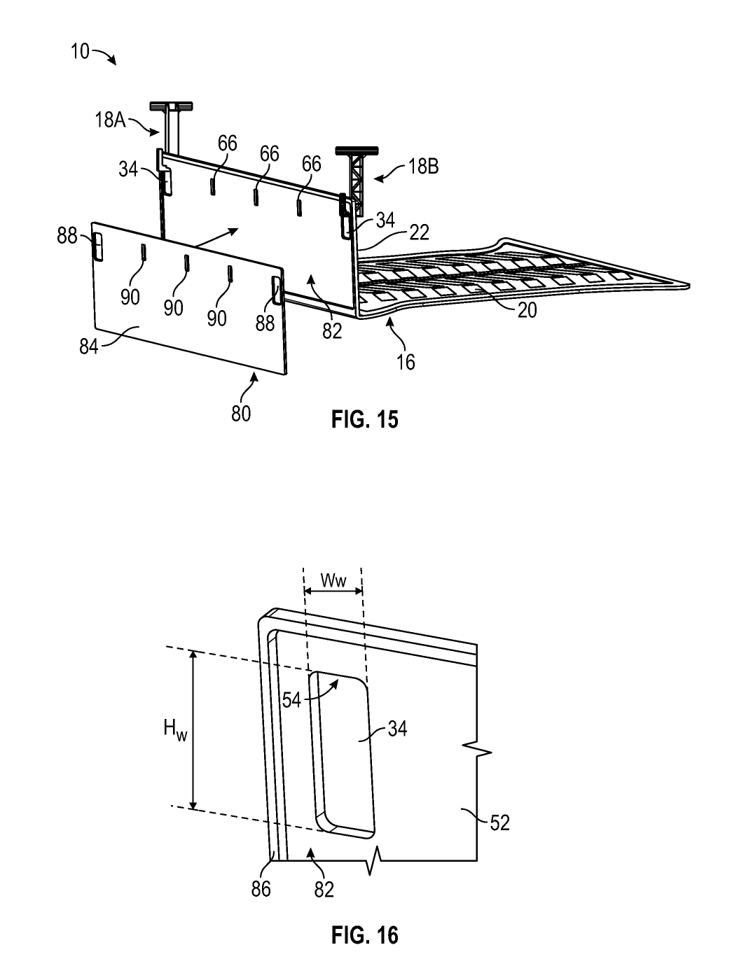

In an example, the rigid reinforcing member 80 can be at least partially nested within the partition portion 22. The partition portion 22 can include a recess 82 (FIGS. 15 and 16) that can at least partially receive the rigid reinforcing member 80. The recess 82 can be sized so that the rigid reinforcing member 80 is completely received therein, e.g., so that an exposed surface 84 of the rigid reinforcing member 80 is flush or substantially flush with a rear surface 86 of the partition portion 22 that surrounds the recess 82. In an example, the partition portion 22 can have an overall thickness of from about ¼ inch (about 6.4 mm) to about ¾ inch (about 19 mm), such as about ⅜ inch (about 9.5 mm) or about ½ inch (about 13 mm), the depth Dᵣ of the recess 82 can be from about ⅛ inch (about 3 mm) to about ⅝ inch (about 16 mm), such as about ¼ inch (6.4 mm) for a ⅜ inch (about 9.5 mm) thick partition portion 22 or about ⅜ inch (about 9.5 mm) for a ½ inch (about 13 mm) thick partition portion 22. The rigid reinforcing member 80 can have a thickness Tᵣ that is substantially the same as the depth Dᵣ of the recess 82, e.g., from about ⅛ inch (about 3 mm) to about ⅝ inch (about 16 mm), such as about ¼ inch (6.4 mm) for a ⅜ inch (about 9.5 mm) thick partition portion 22 or about ⅜ inch (about 9.5 mm) for a ½ inch (about 13 mm) thick partition portion 22.

The rigid reinforcing member 80 can includes structures that correspond with the structures of the partition portion 22 described above. For example, the rigid reinforcing member 80 can include one or more mounting windows 88 (FIG. 15) that can be aligned or substantially aligned with the mounting windows 34 of the partition portion 22 to receive the mounting hooks 18. The rigid reinforcing member 80 can include one or more tying holes 90 (FIG. 15) that can be aligned or substantially aligned with the tying holes 66 of the partition portion 22 to receive and engage with a tying device 68 (e.g., a bungee cord 68). The rigid reinforcing member 80 can include cleats (not shown) to provide for airflow and water drainage when the partition portion 22 is in the lowered position, similar to the cleats 76 described above. The exposed surface 84 of the rigid reinforcing member 80 can be coated with a material to provide desired characteristics to the rigid reinforcing member 80, such as a non-slip material to prevent or reduce sliding of cargo 30 along the exposed surface 84.

The above Detailed Description is intended to be illustrative, and not restrictive. For example, the above-described examples (or one or more elements thereof) can be used in combination with each other. Other embodiments can be used, such as by one of ordinary skill in the art upon reviewing the above description. Also, various features or elements can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a molding system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract is provided to comply with 37 C.F.R. §1.72(b), to allow the reader to quickly ascertain the nature of the technical disclosure. It is submitted with the understanding that it will not be used to interpret or limit the scope or meaning of the claims.

Although the invention has been described with reference to exemplary embodiments, those skilled in the art will recognize that changes may be made in form and detail without departing from the spirit and scope of the invention.

What is claimed is:

1. A cargo mat system comprising:
a cargo mat comprising;
a mat portion configured to cover at least a portion of a cargo area of a vehicle; and
a partition portion coupled to the mat portion, the partition portion comprising one or more securing structures,
wherein the partition portion is movable from a lowered position to a raised position relative to the mat portion; and
one or more partition mounts coupleable to the vehicle, the one or more partition mounts engageable with the one or more securing structures to hold the partition portion in the raised position relative to the mat portion.

2. The cargo mat system of claim 1, wherein at least a portion of the mat portion and at least a portion of the partition portion of the cargo mat are formed as a molded unitary structure.

3. The cargo mat system of claim 2, wherein the molded unitary structure comprises a living hinge between the mat portion and the partition portion.

4. The cargo mat system of claim 1, wherein the one or more partition mounts comprises one or more mounting hooks configured to hook onto a corresponding one of the one or more securing structures.

5. The cargo mat system of claim 4, wherein each of the one or more mounting hooks comprises a first substantially vertical member mountable to the vehicle, a substantially horizontal member coupled to the first substantially vertical member, and a second substantially vertical member coupled to the substantially horizontal member.

6. The cargo mat system of claim 1, wherein the one or more partition mounts comprises one or more straps or tying device configured to couple with a corresponding one of the one or more securing structures.

7. The cargo mat system of claim 1, wherein the one or more partition mounts comprises a toughened polyamide or a super toughened polyamide.

8. The cargo mat system of claim 1, further comprising a rigid reinforcing member coupled to the partition portion of the cargo mat.

9. The cargo mat system of claim 8, wherein the partition portion comprises a recess for at least partially receiving the rigid reinforcing member.

10. The cargo mat system of claim 8, wherein the rigid reinforcing member comprises a rigid plastic member.

11. The cargo mat system of claim 1, wherein the cargo mat provides a generally flat top surface when the partition portion is in the lowered position.

12. A cargo mat system comprising:
a molded cargo mat with a molded unitary structure comprising;
a mat portion configured to cover at least a portion of a cargo area of a vehicle, and
a partition portion pivotally coupled to the mat portion by at least one living hinge, the partition portion comprising one or more mounting windows therein,
wherein the partition portion is pivotable from a lowered position to a raised position relative to the mat portion;
a rigid reinforcing member coupled to the partition portion; and
one or more partition mounts coupleable to the vehicle, each of the one or more partition mounts being engageable with a corresponding one of the one or more mounting windows to secure the partition portion in the raised position relative to the mat portion.

13. The cargo mat system of claim 12, wherein the partition portion comprises a recess, and wherein the rigid reinforcing member is at least partially nested within the recess.

14. The cargo mat system of claim 12, wherein each of the one or more partition mounts comprises a first substantially vertical member mountable to the vehicle, a substantially horizontal member coupled to the first substantially vertical member, and a second substantially vertical member coupled to the substantially horizontal member.

15. The cargo mat system of claim 12, wherein the one or more partition mounts comprises one or more straps or tying device configured to couple with a corresponding one of the one or more securing structures.

16. A motor vehicle, comprising:
a cargo area for storage or transport of cargo, the cargo area comprising a floor;
a cargo mat comprising;
a mat portion configured to cover at least a portion of the floor; and
a partition portion coupled to the mat portion, the partition portion comprising one or more securing structures,
wherein the partition portion is movable from a lowered position to a raised position relative to the mat portion; and
one or more partition mounts coupled to the motor vehicle, the one or more partition mounts engageable with the one or more securing structures to hold the partition portion in the raised position relative to the mat portion.

17. The motor vehicle of claim 16, wherein the cargo area comprises a pickup truck bed.

18. The motor vehicle of claim 16, wherein the cargo mat is a molded unitary structure comprising, wherein the partition portion is pivotally coupled to the mat portion by at least one living hinge.

19. The motor vehicle of claim 16, wherein the one or more partition mounts comprises one or more mounting hooks configured to hook onto a corresponding one of the one or more securing structures or one or more straps or tying device configured to couple with a corresponding one of the one or more securing structures.

20. The motor vehicle of claim 16, further comprising a rigid reinforcing member coupled to the partition portion of the cargo mat.
